(19) United States
(12) Patent Application Publication
(10) Pub. No.: US 2026/0252269 A1
(43) Pub. Date: Aug. 27, 2026

(54) MANAGING READ OPERATIONS IN A MEMORY SYSTEM

(71) Applicant: Yangtze Memory Technologies Co., Ltd., Wuhan (CN)

(72) Inventors: Xinyu WANG, Wuhan (CN); He LIU, Wuhan (CN); Wen LUO, Wuhan (CN)

(21) Appl. No.: 19/175,350

(22) Filed: Apr. 10, 2025

(30) Foreign Application Priority Data
Feb. 26, 2025 (CN) 202510223100.9

(51) Int. Cl. G06F 3/06

(52) U.S. Cl. CPC G06F 3/0659; G06F 3/0619; G06F 3/0656; G06F 3/0679

(57) ABSTRACT

Methods, devices, and systems for managing memory devices are provided. In one aspect, a memory system can include a memory device and a memory controller coupled to the memory device. The memory controller is configured to perform operations including receiving a first read command that indicates to read first data associated with a first logical address; in response to receiving a second read command that indicates to read the first data associated with the first logical address, storing the first data in a buffer of the memory controller, wherein the first data remains in the buffer after the second read command is completed; and in response to receiving a third read command that indicates to read the first data associated with the first logical address, sending the first data from the buffer.

### CROSS-REFERENCE TO RELATED APPLICATIONS

This application claims priority to Chinese Patent Application No. 202510223100.9, filed on February 26, 2025, which is hereby incorporated by reference in its entirety.

### TECHNICAL FIELD

The present disclosure generally relates to memory devices and memory systems, and in particular, to managing read operations in memory systems.

### BACKGROUND

Flash memory is a low-cost, high-density, nonvolatile solid-state storage medium that can be electrically erased and reprogrammed. Flash memory includes NOR flash memory and NAND flash memory. Various operations can be performed by a flash memory, for example, program (write) or read operations.

### SUMMARY

The present disclosure involves methods, apparatuses, and systems for managing read operations in a memory system. In one example, a memory system can include a memory device and a memory controller coupled to the memory device. The memory controller is configured to perform operations including receiving a first read command that indicates to read first data associated with a first logical address; in response to receiving a second read command that indicates to read the first data associated with the first logical address, storing the first data in a buffer of the memory controller, where the first data remains in the buffer after the second read command is completed; and in response to receiving a third read command that indicates to read the first data associated with the first logical address, sending the first data from the buffer.

In some implementations, the operations include, in response to receiving the first read command that indicates to read the first data associated with the first logical address: storing the first data in the buffer of the memory controller; and deleting the first data from the buffer after the first read command is completed.

In some implementations, the operations include, in response to receiving the first read command that indicates to read the first data associated with the first logical address, determining whether the first data is stored in the buffer; and in response to determining that the first data is stored in the buffer, sending the first data from the buffer.

In some implementations, a duration of executing the third read command is shorter than a duration of executing the first read command or the second read command.

In some implementations, the second read command is received from a host after the first read command is completed. The third read command is received from the host after the second read command is completed.

In some implementations, the first read command and the second read command are received within a pre-set duration, and the second read command and the third read command are received within the pre-set duration.

In some implementations, the operations further include, after receiving the first read command, storing the first logical address in the memory controller.

In some implementations, the operations further include, in response to receiving a fourth read command that indicates to read second data associated with a second logical address, deleting the first data from the buffer, and storing the second logical address in the memory controller in replacement of the first logical address.

In some implementations, the operations include in response to receiving a write command or a trim command, deleting the first data from the buffer, and deleting the first logical address stored in the memory controller.

In some implementations, a size of the first data is 4kB.

In some implementations, the operations include, in response to receiving the first read command, sending first read sequences to the memory device, where the first read sequences indicate to read the first data; and in response to receiving the second read command, sending second read sequences to the memory device, where the second read sequences indicate to read the first data. The memory controller does not send read sequences to the memory device in response to receiving the third read command.

In some implementations, the operations include, in response to receiving the first read command, receiving the first data from the memory device; and in response to receiving the second read command, receiving the first data from the memory device. The memory controller does not receive data from the memory device in response to receiving the third read command.

Another aspect of the present disclosure features a memory controller. The memory controller includes one or more processors, a buffer, and an interface. The one or more processors are configured to perform operations including: receiving, through the interface, a first read command that indicates to read first data associated with a first logical address; in response to receiving, through the interface, a second read command that indicates to read the first data associated with the first logical address, storing the first data in the buffer, where the first data remains in the buffer after the second read command is completed; and in response to receiving, through the interface, a third read command that indicates to read the first data associated with the first logical address, sending the first data from the buffer.

In some implementations, a duration of executing the third read command is shorter than a duration of executing the first read command or the second read command.

In some implementations, the first read command and the second read command are received within a pre-set duration, and the second read command and the third read command are received within the pre-set duration.

In some implementations, the operations include, after receiving the first read command, storing the first logical address in the memory controller.

In some implementations, the operations include, in response to receiving a fourth read command that indicates to read second data associated with a second logical address, deleting the first data from the buffer, and storing the second logical address in the memory controller in replacement of the first logical address.

In some implementations, the operations include, in response to receiving a write command or a trim command, deleting the first data from the buffer, and deleting the first logical address stored in the memory controller.

In some implementations, the operations include: in response to receiving the first read command, sending first read sequences to a memory device coupled to the memory controller, where the first read sequences indicate to read the first data; and in response to receiving the second read command, sending second read sequences to the memory device, where the second read sequences indicate to read the first data. The memory controller does not send read sequences to the memory device in response to receiving the third read command.

A further aspect of the present disclosure features a method of operating a memory system. The method includes receiving a first read command that indicates to read first data associated with a first logical address; in response to receiving a second read command that indicates to read the first data associated with the first logical address, storing the first data in a buffer of a memory controller of the memory system, where the first data remains in the buffer after the second read command is completed; and in response to receiving a third read command that indicates to read the first data associated with the first logical address, sending the first data from the buffer.

A yet further aspect of the present disclosure features a non-transitory, computer readable medium. The non-transitory, computer readable medium stores one or more instructions executable by a memory system to perform operations including: receiving a first read command that indicates to read first data associated with a first logical address; in response to receiving a second read command that indicates to read the first data associated with the first logical address, storing the first data in a buffer of a memory controller of the memory system, where the first data remains in the buffer after the second read command is completed; and in response to receiving a third read command that indicates to read the first data associated with the first logical address, sending the first data from the buffer.

An additional aspect of the present disclosure features a system including a host and a memory system coupled to the host. The host is configured to send commands to the memory system. The memory system can include a memory device and a memory controller coupled to the memory device. The memory controller is configured to perform operations including receiving a first read command that indicates to read first data associated with a first logical address; in response to receiving a second read command that indicates to read the first data associated with the first logical address, storing the first data in a buffer of the memory controller, where the first data remains in the buffer after the second read command is completed; and in response to receiving a third read command that indicates to read the first data associated with the first logical address, sending the first data from the buffer.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system having a memory device, according to some aspects of the present disclosure.

FIGS. 2A-2B illustrate example storage products, according to some aspects of the present disclosure.

FIG. 3 illustrates an example of a schematic diagram of a memory device including peripheral circuits, according to some aspects of the present disclosure.

FIG. 4 illustrates some example peripheral circuits, according to some aspects of the present disclosure.

FIG. 5A illustrates a block diagram of an example memory system including an example memory controller, according to some aspects of the present disclosure.

FIG. 5B illustrates a block diagram of an example memory controller, according to some aspects of the present disclosure.

FIG. 6 illustrates a swimlane diagram of an example method of performing a read operation, according to some aspects of the present disclosure.

FIG. 7 illustrates a swimlane diagram of another example method of performing a read operation, according to some aspects of the present disclosure.

FIG. 8 illustrates a flow chart of an example process of performing a read operation.

FIG. 9 illustrates a flow chart of an example method of operating a memory system, according to some aspects of the present disclosure.

Like reference numbers and designations in the various drawings indicate like elements.

### DETAILED DESCRIPTION

This specification relates to devices, systems, and methods for managing read operations in a memory system (e.g., a solid-state drive (SSD)). In some cases, a memory controller of a memory system receives consecutive read commands (e.g., read commands to read 4kB of data) that indicate to read data associated with the same logical address, or in other words, to read the same data. For example, a small file may need to be read repeatedly, or multiple users may need to access the same file or the same data block. For another example, during game loading, a user may need to repeatedly read the same data block.

In some cases, the memory system executes each of the consecutive read commands by performing a normal read operation. During each normal read operation, the memory controller can covert the logical address to a physical address, read data from the physical address by sending read sequences to the memory device, temporarily store the data in a data buffer of the memory controller, and send the data from the data buffer to the host. As such, a latency of executing the consecutive read commands may be long.

The present disclosure provides techniques to efficiently execute consecutive read commands that indicate to read data associated with the same logical address. In some implementations, in response to receiving a first read command of the consecutive read commands, the memory system can perform a normal read operation, and store the logical address in the memory controller. In response to receiving a second read command of the consecutive read commands, the memory system can perform a normal read operation, and keep the data in the data buffer after the second read command is completed. As such, in response to receiving a third or a subsequent read command of the consecutive read commands, the memory system can perform a quick read operation. During a quick read operation, the memory controller can send data directly from the data buffer, without needing to convert the logical address to a physical address or to read the data from the memory device. As such, a latency of executing the consecutive read commands can be reduced.

In some implementations, the described techniques can achieve one or more technical effects. For example, the described techniques can improve the efficiency and reduce the latency of executing consecutive read commands that indicate to read data associated with the same logical address. For another example, PCMark testing can evaluate the overall performance (e.g., read and write speeds) of a memory system by simulating real-world usage scenarios such as web browsing, video playback, and office tasks. PCMark testing can include specific tests, such as a CSP1 test, that involve executing consecutive read commands that indicate to read the same data. By implementing the described techniques, PCMark testing scores of the memory system can be improved. In addition, the described techniques do not require hardware changes, and are therefore cost-effective. In some implementations, additional or different technical effects can be achieved.

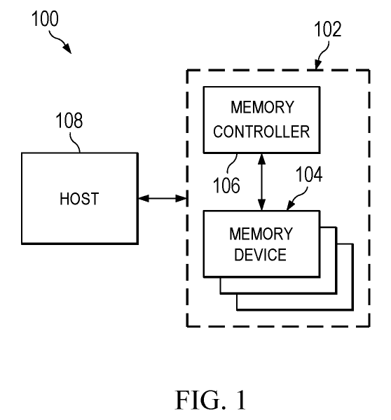

FIG. 1 illustrates a block diagram of an example system 100 having a memory device, according to some aspects of the present disclosure. The system 100 can be a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having storage therein. As shown in FIG. 1, the system 100 can include a host 108 and a memory system 102 having one or more memory devices 104 and a memory controller 106. The host 108 can include one or more processors of an electronic device. The processor can be a central processing unit (CPU), or a system-on-chip (SoC), such as an application processor (AP). The host 108 can be configured to send or receive data and commands to or from the memory systems 102.

The memory device 104 can be any memory device disclosed in the present disclosure, such as a NAND Flash memory device. It is noted that the NAND Flash is only one example of memory device for illustrative purposes. It can include any suitable solid-state, non-volatile memory, e.g., NOR Flash, Ferroelectric RAM (FeRAM), Phase-change memory (PCM), Magne-to-resistive random- access memory (MRAM), Spin-transfer torque magnetic random-access memory (STT-RAM), or Resistive random-access memory (RRAM), etc. In some implementations, memory device 104 includes a three-dimensional (3D) NAND Flash memory device.

The memory controller 106 can be implemented by microprocessors, microcontrollers (a.k.a. microcontroller units (MCUs)), digital signal processors (DSPs), application-specific integrated circuits (ASICs), field-programmable gate arrays (FPGAs), programmable logic devices (PLDs), state machines, gated logic, discrete hardware circuits, and other suitable hardware, firmware, and/or software configured to perform the various functions described below in detail.

The memory controller 106 is coupled to the memory device 104 and to the host 108, and is configured to control the memory device 104, according to some implementations. The memory controller 106 can manage the data stored in the memory device 104 and can communicate with the host 108. In some implementations, the memory controller 106 is designed for operating in a low duty-cycle environment, such as secure digital (SD) cards, compact Flash (CF) cards, universal serial bus (USB) Flash drives, or other media for use in electronic devices, such as personal computers, digital cameras, mobile phones, etc. In some implementations, memory controller 106 is designed for operating in a high duty-cycle environment solid state drives (SSDs) or embedded multi-media-cards (eMMCs) used as data storage for mobile devices, such as smartphones, tablets, laptop computers, etc., and enterprise storage arrays. The memory controller 106 can be configured to control operations of the memory device 104, such as read, erase, and program operations. The memory controller 106 can also be configured to manage various functions with respect to the data stored or to be stored in the memory device 104 including, but not limited to bad-block management, garbage collection, logical-to-physical address conversion, logical-to-physical mapping management, wear leveling, etc. In some implementations, the memory controller 106 is further configured to process error correction codes (ECCs) with respect to the data read from or written to the memory device 104. Any other suitable functions can be performed by the memory controller 106 as well, for example, formatting the memory device 104.

The memory controller 106 can communicate with an external device (e.g., the host 108) according to a particular communication protocol. For example, the memory controller 106 can communicate with the external device through at least one of various interface protocols, such as a USB protocol, an MMC protocol, a peripheral component interconnection (PCI) protocol, a PCI- express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc. The memory controller 106 is configured to receive and transmit a command to and from the host 108, and execute or perform multiple functions and operations provided in the present disclosure, which will be described later.

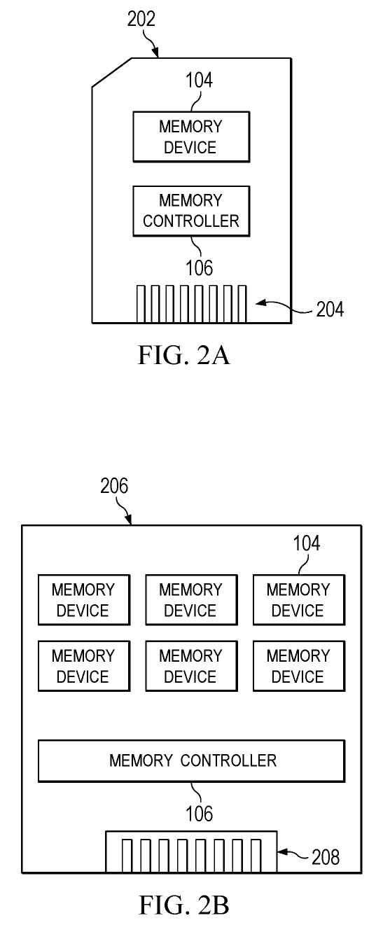

The memory controller 106 and the one or more memory devices 104 can be integrated into various types of storage devices. For example, the memory controller 106 and the one or more memory devices 104 can be packaged in a universal Flash storage (UFS) package or an eMMC package. In one example as shown in FIG. 2A, the memory controller 106 and a single memory device 104 can be integrated into a memory card 202. The memory card 202 can include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. The memory card 202 can further include a memory card connector 204 coupling the memory card 202 with a host (e.g., host 108 in FIG. 1). In another example as shown in FIG. 2B, the memory controller 106 and multiple memory devices 104 can be integrated into an SSD 206. The SSD 206 can further include an SSD connector 208 that couples the SSD 206 with a host (e.g., host 108 in FIG. 1). In some implementations, the storage capacity and/or the operation speed of the SSD 206 is greater than those of the memory card 202.

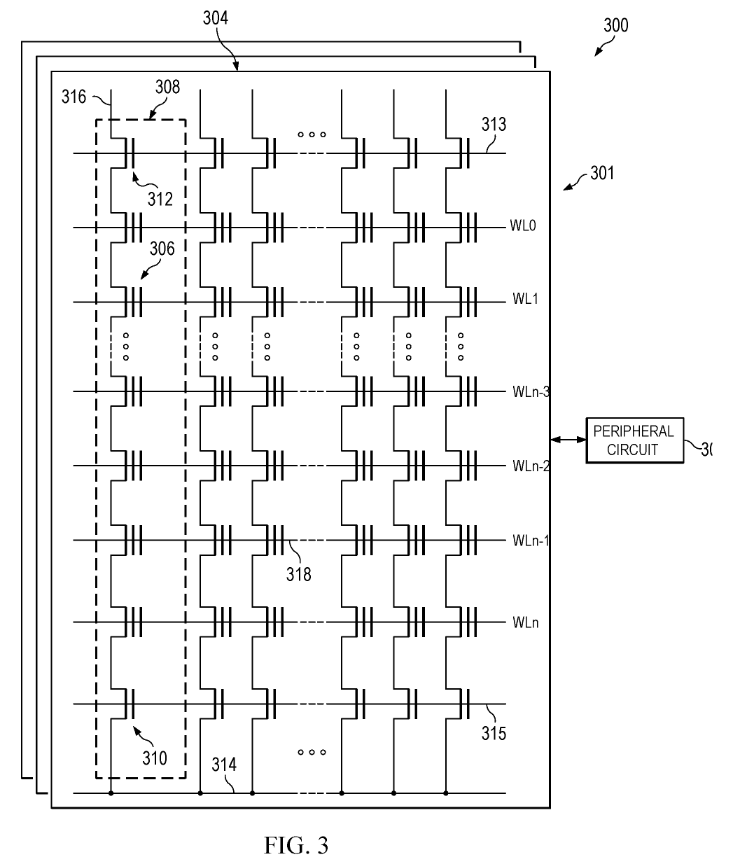

FIG. 3 illustrates an example of a schematic diagram of a memory device 300 including peripheral circuits, according to some aspects of the present disclosure. The memory device 300 can include a memory cell array 301 and peripheral circuits 302 coupled to the memory cell array 301. The memory cell array 301 can be a NAND Flash memory cell array in which memory cells 306 are provided in the form of an array of NAND memory strings 308 each extending vertically above a substrate (not shown in FIG. 3). In some implementations, each NAND memory string 308 includes a plurality of memory cells 306 coupled in series and stacked vertically. Each memory cell 306 can hold a continuous, analog value, such as an electrical voltage or charge that depends on the number of electrons trapped within a storage layer of the memory cell 306. The logic state (i.e., data) of each memory cell 306 in a memory block 304 can be determined based on the threshold voltage Vth of the memory cell 306. Each memory cell 306 can be a floating gate type memory cell including a floating-gate transistor, or a charge trap type memory cell including a charge-trap transistor.

In some implementations, each memory cell 306 is a single-level cell (SLC) with two possible memory states that can store one bit of data. For example, the first memory state “0” can correspond to a first range of voltages, and the second memory state “1” can correspond to a second range of voltages. In some implementations, each memory cell 306 is a multi-level cell (MLC) that is capable of storing more than one bit of data in more than two memory states. For example, the MLC can store two bits per cell, three bits per cell (also known as triple-level cell (TLC)), or four bits per cell (also known as a quad-level cell (QLC)). Each MLC can be programmed to support a range of possible nominal storage values. In one example, if each MLC stores two bits of data, then the MLC can be programmed to one of three possible programming levels from an erased state by writing one of three possible nominal storage values to the cell. A fourth nominal storage value can be used for the erased state.

As shown in FIG. 3, each NAND memory string 308 can include a source select gate (SSG) 310 at its source end and a drain select gate (DSG) 312 at its drain end. The SSG 310 and the DSG 312 can be configured to activate selected NAND memory strings 308 (columns of the array) during read and program operations. In some implementations, the sources of NAND memory strings 308 in the same memory block 304 are coupled through a same source line (SL) 314, e.g., a common SL. In other words, NAND memory strings 308 in the same memory block 304 have an array common source (ACS), according to some implementations. The DSG 312 of each NAND memory string 308 is coupled to a respective bit line 316 from which data can be read or written via an output bus (not shown), according to some implementations. In some implementations, each NAND memory string 308 is configured to be selected or deselected by applying a select voltage (e.g., above the threshold voltage of the transistor having the DSG 312) or a deselect voltage (e.g., 0 V) to the respective DSG 312 through one or more DSG lines 313, and/or by applying a select voltage (e.g., above the threshold voltage of the transistor having the SSG 310) or a deselect voltage (e.g., 0 V) to the respective SSG 310 through one or more SSG lines 315.

As shown in FIG. 3, NAND memory strings 308 can be organized into multiple memory blocks 304, each of which can have a common SL 314 coupled to the ACS. In some implementations, each memory block 304 can serve as a basic data unit for erase operations, such that memory cells 306 on the same memory block 304 are erased at the same time. To erase memory cells 306 in a selected memory block 304, the SL 314 coupled to the selected memory block 304 and unselected memory blocks in the same plane can be biased with an erase voltage. For example, the erase voltage can be a high positive voltage (e.g., 20 V or more). In some implementations, an erase operation can be performed at a half-block level, a quarter-block level, or a level having any suitable number of memory blocks or fractions of a memory block.

The memory cells 306 of adjacent NAND memory strings 308 can be coupled through word lines 318. The word line 318 can select which row of memory cells 306 is affected by read and program operations. Each word line 318 can include a gate line coupled to a plurality of control gates (gate electrodes) of a plurality of memory cells 306. Example word lines shown in FIG. 3 are between one or more DSG lines 313 and one or more SSG lines 315.

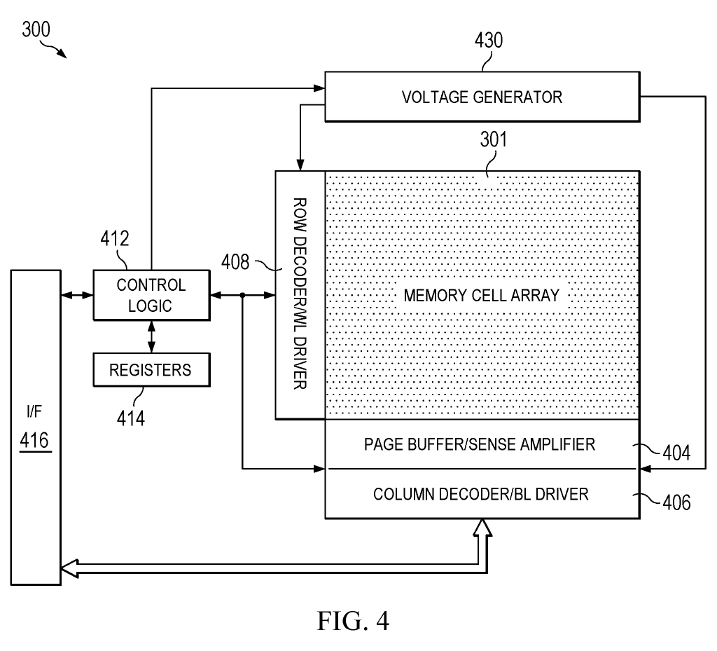

FIG. 4 illustrates some example peripheral circuits 302, according to some aspects of the present disclosure. The peripheral circuits 302 can be coupled to the memory cell array 301 through bit lines 316, word lines 318, SLs 314, SSG lines 315, and DSG lines 313. The peripheral circuits 302 can include any suitable analog, digital, and mixed-signal circuits for facilitating the operations of the memory cell array 301 by applying and sensing voltage signals and/or current signals to and from each target memory cell 306 through bit lines 316, word lines 318, SLs 314, SSG lines 315, and DSG lines 313. The peripheral circuits 302 can include various types of peripheral circuits formed using metal-oxide-semiconductor (MOS) technologies. The example peripheral circuits 302 include a page buffer/sense amplifier 404, a column decoder/bit line driver 406, a row decoder/word line driver 408, a voltage generator 410, control logic 412, registers 414, an interface 416, and a data bus. In some examples, additional peripheral circuits not shown in FIG. 4 may be included as well.

The page buffer/sense amplifier 404 can be configured to read and program (write) data from and to memory cell array 301 according to the control signals from control logic 412. In an example, the page buffer/sense amplifier 404 may store one page of program data (write data) to be programmed into one page 320 of the memory cell array 301. In another example, the page buffer/sense amplifier 404 may perform program verify operations to ensure that the data have been properly programmed into memory cells 306 coupled to selected word lines 418. In still another example, the page buffer/sense amplifier 404 may also sense the low power signals from the bit line 316 that represents a data bit stored in memory cell 306, and amplify the small voltage swing to recognizable logic levels in a read operation. The column decoder/bit line driver 406 can be configured to be controlled by the control logic 412 and select one or more NAND memory strings 308 by applying bit line voltages generated from the voltage generator 410.

The row decoder/word line driver 408 can be configured to be controlled by the control logic 412 and select/deselect memory blocks 304 of the memory cell array 301 and select/deselect word lines 418 of the memory block 304. The row decoder/word line driver 408 can be further configured to drive word lines 418 using word line voltages generated from the voltage generator 410. In some implementations, the row decoder/word line driver 408 can also select/deselect and drive SSG lines 415 and DSG lines 413. As described below in detail, the row decoder/word line driver 408 is configured to apply a program voltage to selected word line 418 in a program operation on memory cell 306 coupled to selected word line 418.

The voltage generator 410 can be configured to be controlled by the control logic 412 and generate the word line voltages (e.g., read voltage, program voltage, pass voltage, local voltage, verify voltage, etc.), bit line voltages, and source line voltages to be supplied to the memory cell array 301.

The control logic 412 can be coupled to each peripheral circuit described above and configured to control operations of each peripheral circuit. The registers 414 can be coupled to the control logic 412 and include status registers, command registers, and address registers for storing status information, command operation codes (OP codes), and command addresses for controlling the operations of each peripheral circuit.

The interface 416 can be coupled to the control logic 412 and act as a control buffer to buffer and relay control commands received from a host (not shown) to the control logic 412 and status information received from the control logic 412 to the host. The interface 416 can also be coupled to the column decoder/bit line driver 406 via a data bus, and act as a data input/output (I/O) interface and a data buffer to buffer and relay data to and from the memory cell array 301.

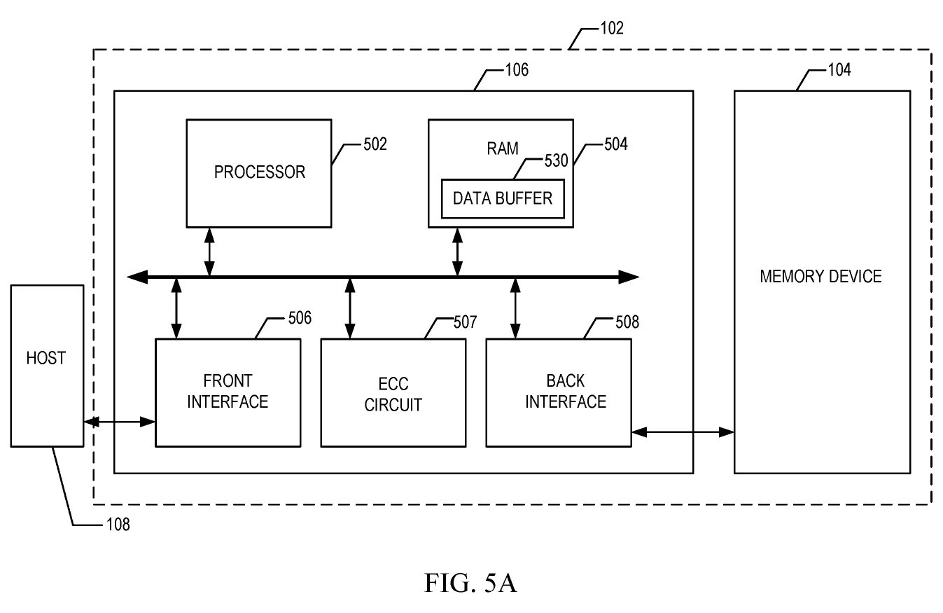

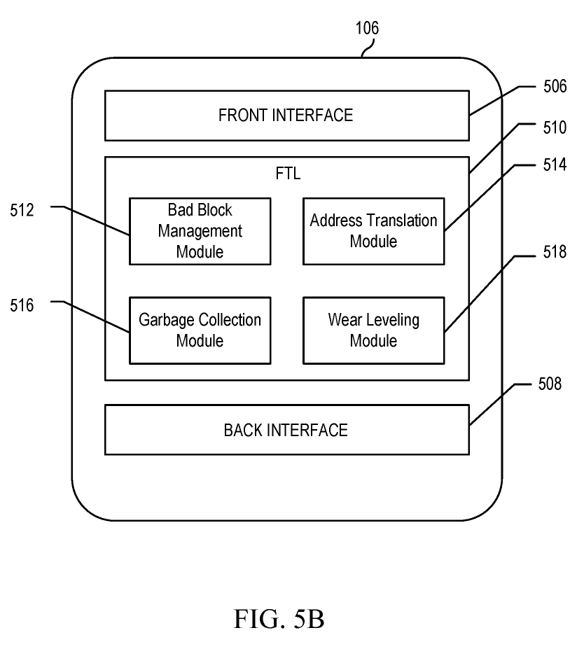

FIG. 5A is a block diagram of an example memory system 102 including an example memory controller 106. The memory system 102 further includes a memory device 104. The memory system can be coupled to a host 108.

The memory controller 106 is configured to operate the memory device 104 at the request of the host 108. The memory controller 106 is configured to drive firmware for controlling the operations of the memory device 104. The memory controller 106 can include a random access memory (RAM) 504, a processor 502, a front interface 506, an error-correction code (ECC) circuit 507, and a back interface 508.

The memory controller 106 is configured to communicate with the host 108 through the front interface 506. For example, the memory controller 106 can receive commands from the host 108 and send responses to the host 108 through the front interface 506. The memory controller 106 is configured to communicate with the memory device 104 through the back interface 508. For example, the memory controller 106 can send commands to the memory device 104 and receive responses from the memory device 104 through the back interface 508. The back interface 508 may include a NAND flash interface or a NOR flash interface.

The ECC circuit 507 is configured to process error correction codes with respect to the data read from or written to the memory device 104. Example error correction codes can include, but are not limited to, Hamming codes, Reed-Solomon codes, low-density parity check (LDPC) codes, etc. In some implementations, the ECC circuit 507 includes an LPDC encoder configured to generate parity data based on LDPC codes for user data received from the host 108, so that both the user data and the parity data can be sent to the memory device 104 for storage. The ECC circuit 507 can further include an LDPC decoder configured to decode data comprising the user data and the parity data. The ECC circuit can determine whether data stored in the block is read successfully (e.g., with no errors). If the data stored in the block is read successfully, the back interface 508 can forward the data to the front interface 506, so that the front interface 506 can return the data to the host 108. However, if the data stored in the memory block is not read successfully, the back interface 508 can generate data describing a read error on the memory block.

The RAM 504 is configured to be used as an operation memory of the processor 502, a cache memory between the memory device 104 and the host 108, and/or a buffer memory between the memory device 104 and the host 108. The RAM 504 can include one or more data buffers 530, which can temporarily store data e.g., after it is received from the horst and before it is written to the memory device, or after it is read from the memory device and before it is sent to the host.

The processor 502 is configured to control operations of the memory controller 106. The processor 502 is configured to control a read operation, a program operation, an erase operation, or other operations of the memory device 104. In some implementations, the processor 502 can function as a flash translation layer (FTL) 510.

As shown in FIG. 5B, the FTL 510 can include a bad block management module 512, an address translation module 514, a garbage collection (GC) module 516, and a wear leveling module 518. In some implementations, the FTL 510 can include other modules not shown in FIG. 5B.

The bad block management module 512 can be configured to identify failed memory blocks (e.g., by maintaining a bad block table) in the memory device 104. In some implementations, a memory block (e.g., memory block 304 of FIG. 3) may fail due to various factors including manufacturing defects, wear from repeated use, or physical damage. A failed memory block can be skipped or replaced in read or program operations to prevent data corruption.

The address translation module 514 can be configured to translate or map logical data blocks (e.g., received from the host 108) to physical spaces in the memory device 104. In some implementations, the address translation module 514 can translate a logical block address (LBA) provided by the host 108 into a physical block address (PBA) based on a logical to physical (L2P) mapping table. There may be various address mapping methods for the address translation module 514. Examples of address mapping methods include a page mapping method, a block mapping method, and a hybrid mapping method.

The GC module 516 can be configured to migrate data from a source memory block to a target memory block, so that the source memory block can be erased to be available for writing new data. For example, the GC module 516 can be configured to select a source memory block and a target memory block in the memory device 104, read valid data from the source memory block by sending read commands to the memory device 104, write the valid data to the target memory block by sending write commands to the memory device 104, and then erase the source memory block. In some implementations, the GC module 516 can be configured to perform foreground garbage collection on the memory device 104, where the garbage collection is performed when there are not enough memory blocks available for writing new data. In some implementations, the GC module 516 can perform background garbage collection on the memory device 104, where the garbage collection is performed while the memory device is idle (e.g., when there is no pending command to be executed by the memory device).

In some implementations, the GC module 516 performs garbage collection on the memory device 104 based on priority levels of memory blocks in the memory device 104. The priority level can be determined based on valid page count (VPC) of the memory blocks, erase/program (E/P) cycles that the memory blocks have undergone, and/or other metrics. For example, the garbage collection can migrate data from a first memory block having a smaller VPC (which indicates the first memory block has more invalid data) and erases the first memory block, before migrating data from a second memory block having a greater VPC and erasing the second memory block.

The wear leveling module 518 can be configured to balance E/P cycles across memory blocks. For example, the wear leveling module 518 can track the E/P cycle count of each memory block, and write new data to the least-used memory block first. For another example, the wear leveling module 518 can move cold data (data that are not frequently accessed) to another memory block to ensure that different memory blocks wear out at similar rates.

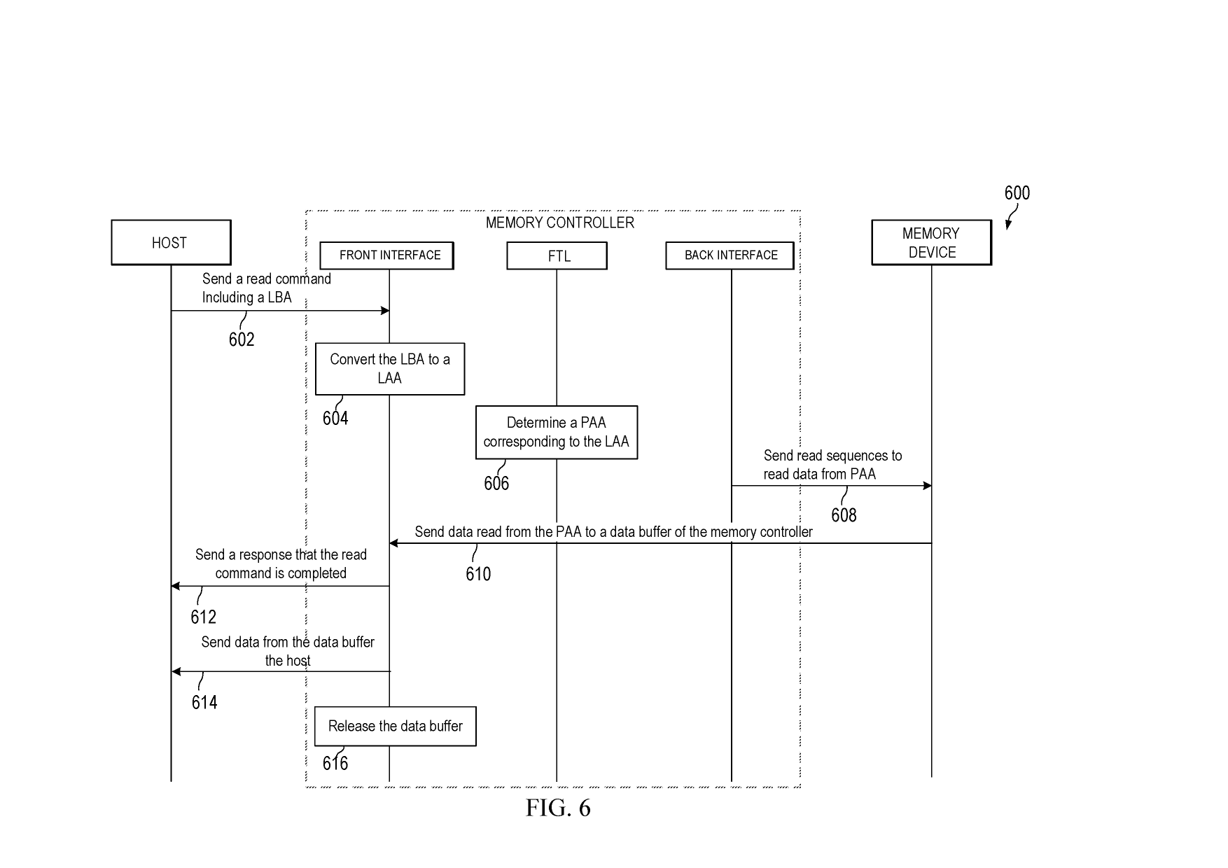

FIG. 6 illustrates a swimlane diagram of an example method 600 of performing a read operation (e.g., a normal read operation), according to some aspects of the present disclosure. During a normal read operation, the memory controller (e.g., the memory controller 106 of FIGS. 1-2B and 5A-5B) can read data from the memory device and temporarily store the data in a data buffer (e.g., a data buffer 530 of FIG. 5A), and send the data from the data buffer to the host.

The operations shown in method 600 may not be exhaustive and that other operations can be performed as well before, after, or in between any of the illustrated operations. Further, some of the operations may be performed simultaneously, or in a different order than shown in FIG. 6. In some implementations, some of the operations may be performed by or one or more components of a device or a system, such as, a memory controller of a peripheral circuit of the memory device.

At 602, the host sends a read command to the memory controller to read data from the memory system. In some implementations, the read command indicates to read 4 kB of data from the memory system. The read command can include a logical address of the data to be read. For example, the read command can include a starting logical block address (LBA) of the data to be read, and a length of LBAs (e.g., a quantity of LBAs). As an example, each LBA can correspond to 512 bytes of data, and a length of LBAs can be eight for a read command to read 4kB of data.

In some implementations, the read command can be a read command with queue depth being 1. That is, the host does not send the next read command to the memory controller until the current read command is completed. The host may send read commands with queue depth being 1 under application scenarios such as file browsing, document editing, and web surfing. In some implementations, the read command can be a read command with queue depth being greater than 1 (e.g., queue depth being 2 or 3). That is, the host can send more than one read command to the memory controller, and the memory system can process more than one read command at the same time (e.g., in parallel). The host may send read commands with queue depth being greater than 1 under application scenarios such as bulk database read operations, cloud computing, and storage server management.

At 604, a front interface (e.g., front interface 506 of FIGS. 5A-5B) of the memory controller converts the starting LBA and the length of LBAs included in the read command into a logical allocation address (LAA). The memory controller can manage data store in the memory system based on LAAs and physical allocation addresses (PAAs). As an example, each LAA corresponds to 4kB of data. The address conversion can be performed by a frontend, which is a layer of firmware functions that operate in conjunction with the front interface to process and manage commands from the host.

At 606, the FTL (e.g., FTL 510 of FIG. 5B) determines a physical address that corresponds to the logical address of the data to be read. For example, the FTL can determine a PAA corresponding to the LAA by looking up a logical-to-physical (L2P) mapping table that maps LAAs to PAAs.

At 608, the back interface (e.g., back interface 508 of FIGS. 5A-5B) of the memory controller can send read sequences to the memory device, where the read sequences indicate to read data from the physical address. For example, the read sequences can indicate to read data from the memory array at a selected location as indicated by the PAA.

At 610, the memory device sends the data read from the PAA to a data buffer of the memory controller. The data buffer can temporarily store the data, before the data is sent to the host.

At 612, the front interface sends a response to the host indicating that the read command is completed.

At 614, the front interface sends the data in the data buffer to the host, and the normal read operation is completed. In some implementations, the front interface can send the response indicating command completion after sending the data from the data buffer.

At 616, after the normal read operation is completed, the memory controller releases the data buffer. In some implementations, data in the data buffer is deleted, so that the data buffer can be available to store data in the next read operation. In some implementations, the data in the data buffer is replaced with new data in the next read operation.

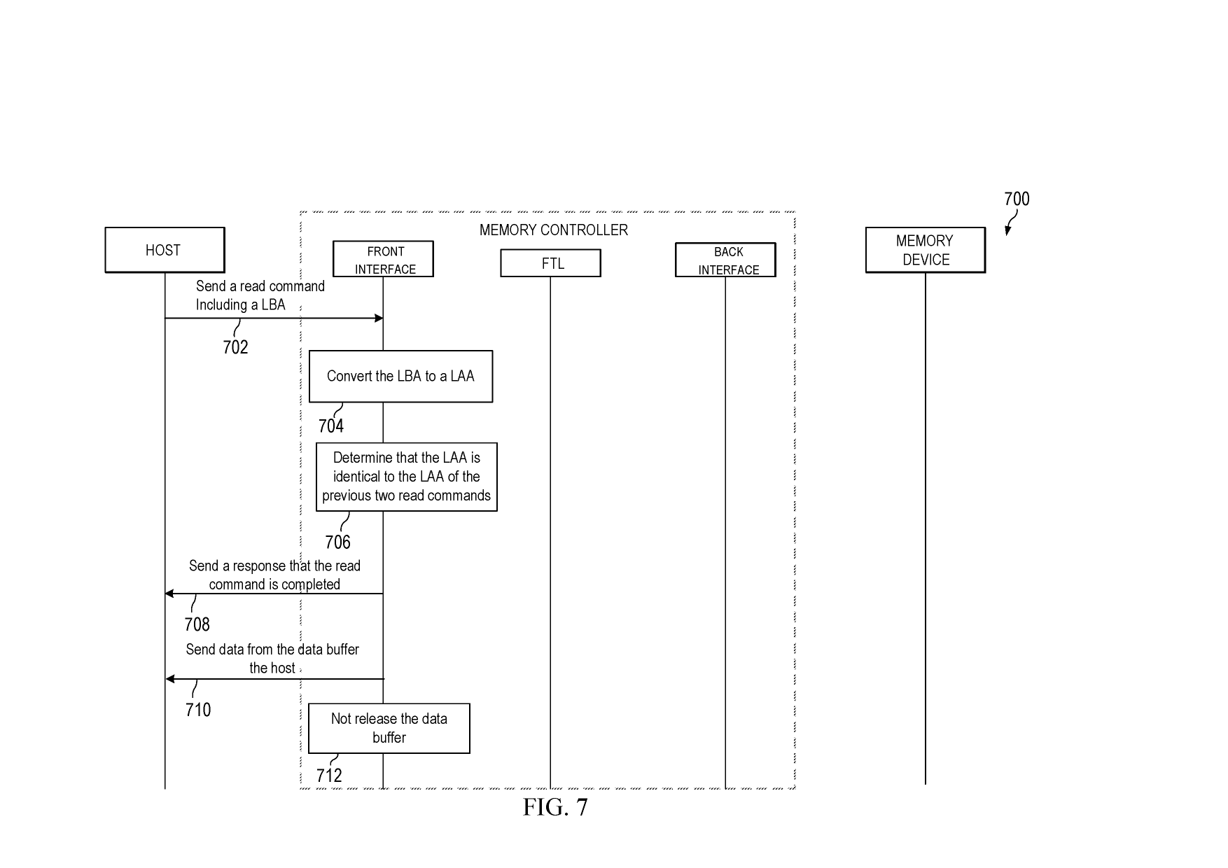

FIG. 7 illustrates a swimlane diagram of another example method 700 of performing a read operation (e.g., a quick read operation). Data to be read during the quick read operation can be stored in a data buffer (e.g., data buffer 530 of FIG. 5A) in advance. As such, during the quick read operation, the memory controller can send data directly from the data buffer to the host, without needing to read data from the memory device.

The operations shown in method 700 may not be exhaustive and that other operations can be performed as well before, after, or in between any of the illustrated operations. Further, some of the operations may be performed simultaneously, or in a different order than shown in FIG. 7. In some implementations, some of the operations may be performed by or one or more components of a device or a system, such as, a memory controller of a peripheral circuit of the memory device.

At 702, the host sends a read command to the memory controller to read data from the memory system. In some implementations, the read command indicates to read 4 kB of data from the memory system. The read command can include a logical address corresponding to the data to be read, e.g., a starting LBA of the data to be read, and a length of LBAs.

At 704, a front interface (e.g., front interface 506 of FIGS. 5A-5B) of the memory controller converts the starting LBA and the length of LBAs included in the read command into a LAA.

At 706, the front interface determines that the logical address included in the read command is identical to the logical address included in the previous two read commands. In some implementations, the memory controller can determine whether the current read command indicates to read data from the same address as the previous read command, and whether the data read during the last read operation remains stored in the data buffer. If the current read command indicates to read data from the same address as the previous read command, and the data read during the last read operation remains stored in the data buffer, the method proceeds to 708.

At 708, the front interface sends a response to the host indicating that the read command is completed.

At 710, the front interface sends the data in the data buffer to the host, and the quick read operation is completed. In some implementations, the front interface can send the response indicating command completion after sending the data from the data buffer.

At 712, after the quick read operation is completed, the memory controller does not release the data buffer. That is, in some implementations, the data in the data buffer remains stored when the method proceeds to the next read operation.

In some implementations, data in the data buffer is deleted, so that the data buffer can be available to store data in the next read operation. In some implementations, the data in the data buffer is replaced with new data in the next read operation.

As shown in FIG. 7, during a quick read operation, the memory controller does not need to covert the logical address to a physical address, or to read data from the memory device, but can send data directly from the data buffer. As such, performing a quick read operation may take less time than performing a normal read operation.

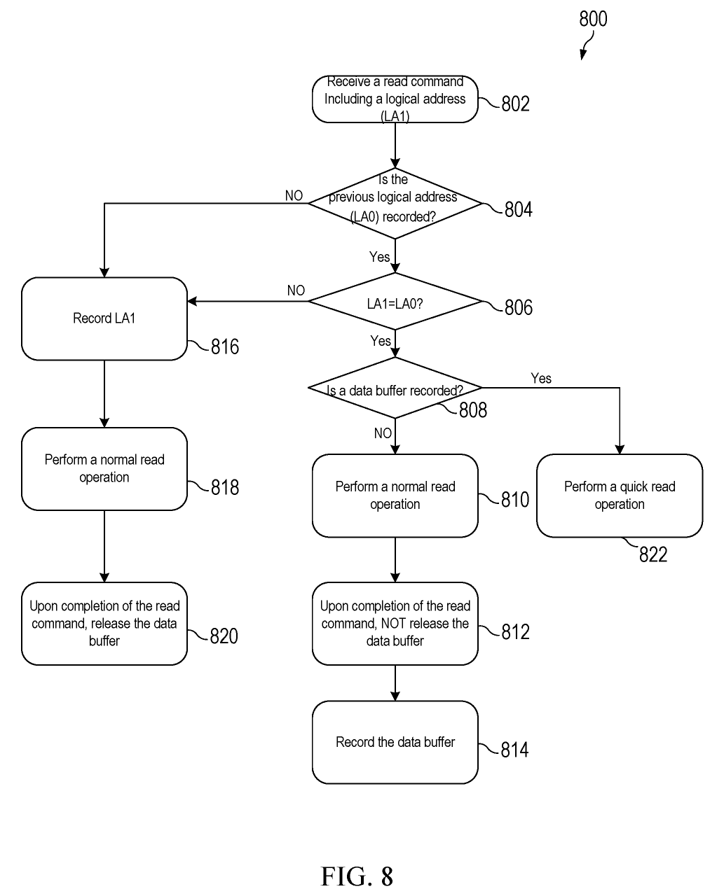

FIG. 8 illustrates a flow chart of an example process 800 of performing a read operation. In some implementations, in response to receiving a read command including a logical address (e.g., LA1), the memory controller can determine (1) whether the logical address is same as the logical address (e.g., LA0) included in the previous read command, and (2) whether the data to be read in the current read operation is already stored in a data buffer. As such, the memory controller can determine whether to perform a normal read operation (e.g., as shown by method 600) or a quick read operation (e.g., as shown by method 700).

The operations shown in process 800 may not be exhaustive and that other operations can be performed as well before, after, or in between any of the illustrated operations. Further, some of the operations may be performed simultaneously, or in a different order than shown in FIG. 8. In some implementations, some of the operations may be performed by or one or more components of a device or a system, such as, a peripheral circuit of the memory device.

At 802, a memory controller (e.g., memory controller 106 of FIGS. 1-2B, 5A-5B) receives a read command that indicates to read data associated with the logical address (LA1). Before 802, the memory controller receives a read command that indicates to read data associated with a previous logical address (LA0), and instructs the memory system to perform the corresponding read operation.

At 804, the memory controller determines whether the previous logical address LA0 is recorded in the memory controller. For example, during the previous read operation, the memory controller can record the logical address LA0 by storing the logical address LA0 in a designated buffer space of the storage medium of the memory controller (e.g., RAM 504 of FIG. 5A). If the memory controller determines that the previous logical address LA0 is recorded, the process 800 proceeds to 806. If the memory controller determines that the previous logical address LA0 is not recorded, the process 800 proceeds to 816.

At 806, the memory controller determines whether the logical address LA1 is the same as the logical address LA0. If the logical address LA1 is the same as the logical address LA0, the process 800 proceeds to 808. If the logical address LA1 is not the same as the logical address LA0, the process 800 proceeds to 816.

At 808, the memory controller determines whether it has recorded a data buffer. For example, during the previous read operation, the memory controller can record the data buffer that stores the data read during the previous read operation, by storing an address or an indicator of the data buffer in a designated buffer space of the storage medium of the memory controller (e.g., RAM 504 of FIG. 5A). In some implementations, the recorded data buffer is not released upon completion of the previous read operation. If a data buffer is recorded by the memory controller, the process 800 proceeds to 822. If no data buffer is recorded by the memory controller, the process 800 proceeds to 810.

At 822, the memory controller instructs the memory system to perform a quick read operation, where the memory controller sends the data to the host directly from the recorded data buffer, without reading data from the memory device.

At 810, the memory controller instructs the memory system to perform a normal read operation, where the memory controller reads data from the memory device and stores the data in a data buffer, and then sends the data from the data buffer to the host.

At 812, upon completion of the read command, the memory controller does not release the data buffer, so that data remains stored in the data buffer when the process 800 proceeds to the next read operation.

At 814, the memory controller records the data buffer, for example, by storing an address or an indicator of the data buffer in a designated buffer space of the RAM of the memory controller.

At 816, the memory controller records the logical address LA1, for example, by storing the logical address LA1 in a designated buffer space of the RAM of the memory controller.

At 818, the memory controller performs a normal read operation, where the memory controller can read data from the memory device, store the data in a data buffer, and then send the data from the data buffer to the host.

At 820, upon completion of the read command, the memory controller releases the data buffer, so that the data buffer can be available to store data read from the memory device in the next read operation.

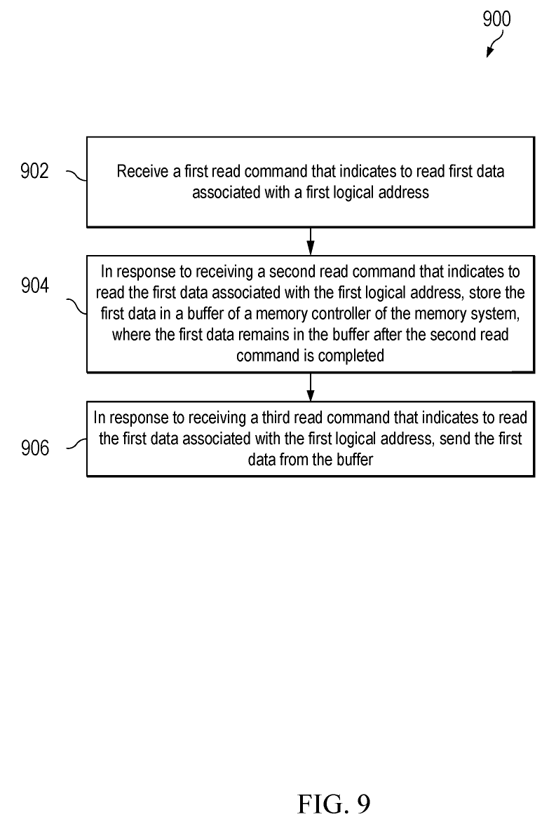

FIG. 9 illustrates a flow chart of an example method 900 of operating a memory system, according to some aspects of the present disclosure.

Method 900 can be performed by any suitable device or system as described herein, for example, according to the example techniques described with respect to FIGS. 1-8. For example, method 900 can be performed by a memory system, such as the memory controller 106 of FIGS. 1-2B and 5A-5B, the memory device 104 of FIGS. 1-2B, the memory device 300 of FIGS. 3-4.

The operations shown in method 900 may not be exhaustive and that other operations can be performed as well before, after, or in between any of the illustrated operations. Further, some of the operations may be performed simultaneously, or in a different order than shown in FIG. 9. In some implementations, some of the operations may be performed by or one or more components of a device or a system, such as, a peripheral circuit of the memory device.

In some implementations, when the memory controller receives consecutive read commands to read data associated with the same logical address (that is, to read data stored at the same physical address in the memory device, or in other words, to read the same data), the memory controller can instruct the memory system to perform a normal read operation in response to the each of the first and the second read commands, and perform a quick read operation in response to each of the third and subsequent read commands. For example, the memory controller can record the logical address associated with the first read command, and not release the data buffer after executing the second read command. As such, the memory controller can determine that the third and subsequent read commands indicate to read data associated with the same logical address, so that the memory controller can send data directly from the data buffer, without needing to read the data again from the memory device.

At 902, the memory controller receives, from a host (e.g., host 108 of FIG. 1), a first read command that indicates to read first data associated with a first logical address. In some implementations, in response to the first read command, the memory controller can instruct the memory system to perform a normal read operation (e.g., as shown by method 600). For example, the memory controller can read the first data from the memory device by sending first read sequences to the memory device, receiving the first data from the memory device, storing the first data in a buffer (e.g., a data buffer 530 of FIG. 5A) of the memory controller, and sending the first data to the host. In some implementations, the memory controller releases the buffer (e.g., by deleting the first data from the buffer) after the first read command is completed. Further, the memory controller can record the first logical address by storing the first logical address in the memory controller.

At 904, the memory controller receives a second read command that indicates to read the first data associated with the first logical address. That is, the second read command indicates to read the same data as the first read command. In response to receiving the second read command, the memory controller can perform another normal read operation (e.g., as shown by method 600). For example, the memory controller can read the first data from the memory device by sending second read sequences to the memory device, receiving the first data from the memory device, storing the first data in a buffer (e.g., a data buffer 530 of FIG. 5A) of the memory controller, and sending the first data to the host. Different from the execution of the first read command, the memory controller does not release the buffer (e.g., by not deleting the first data from the buffer) after the second read command is completed, so that the first data remains in the buffer after the second read command is completed. Further, the memory controller can record the data buffer by storing an address or an indicator of the data buffer in the memory controller.

At 906, the memory controller receives a third read command that indicates to read the first data associated with the first logical address. That is, the third read command indicates to read the same data as the first read command and the second read command. In response to receiving the third read command, the memory controller can perform a quick read operation (e.g., as shown by method 700). For example, the memory controller can read the first data from the buffer, without reading data from the memory device. For example, in response to receiving the third read command, the memory controller does not send read sequences to the memory device and does not receive data from the memory device.

A duration of executing the third read command can be shorter than a duration of executing the first read command and the second read command. The memory controller does not release the buffer (e.g., by not deleting the first data from the buffer) after the third read command is completed, so that the first data remains in the buffer after the third read command is completed.

In some implementations, the host sends the read commands with queue depth being 1. In other words, the host can send each of the first read command, the second read command and the third read command after the previous read command is completed. In some implementations, the host sends the read commands with queue depth being greater than 1. In other words, the host can send the second read command and/or the third read command before the first read command is completed (e.g., at the same time of sending the first read command).

The first read command, the second read command, and the third read command can be consecutive read commands. In some implementations, the memory controller does not receive a write command, a trim command, or any command that may change the mapping relationship between logical addresses and physical addresses, between consecutive read commands. For example, if the memory controller receives a write command or a trim command, the memory controller can delete the recorded logical address (e.g., the first logical address stored in the memory controller), and delete the data (e.g., the first data) from the recorded data buffer. As such, when the memory controller receives a read command after the write command or the trim command, the system can perform a normal read operation to execute the write command.

In some implementations, the second read command is received within a pre-set duration (e.g., 100ms or any suitable time duration) after the first read command is received, and the third read command is received within the pre-set duration after receiving the second read command. In some implementations, if the memory controller does not receive a read command within the pre-set duration, the memory controller can delete the recorded logical address, and delete the data from the recorded data buffer. As such, when the memory controller receives, after the pre-set duration, another command that indicates to read the first data from the first logical address, the memory system can perform a normal read operation to execute the read command.

In some implementations, in response to receiving a fourth read command that indicates to read second data associated with a second logical address (that is, a read command that indicates to read different data), the memory controller can record the second logical address by storing the second logical address in replacement of the first logical address, and delete the first data from the recorded data buffer. Further, the memory system can perform a normal read operation to execute the fourth read command.

The present disclosure also provides a non-transitory computer-readable storage medium. The non-transitory computer-readable storage medium stores one or more instructions (e.g., firmware code of a memory system) that are executable by a processor of a memory controller and/or a peripheral circuit of a memory device. When being executed by the processor of the memory controller and/or the peripheral circuit of the memory device, the instructions in the storage medium can implement method for managing read operations in a memory system, as shown in FIGS. 1-9.

The non-transitory computer-readable storage medium can be an internal storage unit of the device described in any of the foregoing embodiments. For example, the non-transitory computer-readable storage medium can be a hard disk or an internal memory of the device. The non-transitory computer-readable storage medium can also be an external storage device of the device, such as a plug-in hard disk, a smart media card (SMC), a secure digital (SD) card, a flash card, etc. Further, the non-transitory computer-readable storage medium can also include an internal storage unit and an external storage device. In some implementations, the firmware code of the memory system can be stored in a storage medium (e.g., a DRAM coupled to the memory controller) of the memory controller, or in a memory array (e.g., a NAND memory array) of the memory device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required to performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A memory system, comprising:
a memory device; and
a memory controller coupled to the memory device, wherein the memory controller is configured to perform operations comprising:
receiving a first read command that indicates to read first data associated with a first logical address;
in response to receiving a second read command that indicates to read the first data associated with the first logical address, storing the first data in a buffer of the memory controller, wherein the first data remains in the buffer after the second read command is completed; and
in response to receiving a third read command that indicates to read the first data associated with the first logical address, sending the first data from the buffer.

2. The memory system of claim 1, wherein the operations comprise:
in response to receiving the first read command that indicates to read the first data associated with the first logical address:
storing the first data in the buffer of the memory controller; and
deleting the first data from the buffer after the first read command is completed.

3. The memory system of claim 1, wherein the operations comprise:
in response to receiving the third read command that indicates to read the first data associated with the first logical address, determining whether the first data is stored in the buffer; and
in response to determining that the first data is stored in the buffer, sending the first data from the buffer.

4. The memory system of claim 1, wherein a duration of executing the third read command is shorter than a duration of executing the first read command or the second read command.

5. The memory system of claim 1, wherein the second read command is received from a host after the first read command is completed, and wherein the third read command is received from the host after the second read command is completed.

6. The memory system of claim 1, wherein the first read command and the second read command are received within a pre-set duration, and the second read command and the third read command are received within the pre-set duration.

7. The memory system of claim 1, wherein the operations further comprise:
after receiving the first read command, storing the first logical address in the memory controller.

8. The memory system of claim 7, wherein the operations comprise:
in response to receiving a fourth read command that indicates to read second data associated with a second logical address:
deleting the first data from the buffer; and
storing the second logical address in the memory controller in replacement of the first logical address.

9. The memory system of claim 7, wherein the operations comprise:
in response to receiving a write command or a trim command:
deleting the first data from the buffer; and
deleting the first logical address stored in the memory controller.

10. The memory system of claim 1, wherein a size of the first data is 4kB.

11. The memory system of claim 1, wherein the operations comprise:
in response to receiving the first read command, sending first read sequences to the memory device, wherein the first read sequences indicate to read the first data; and
in response to receiving the second read command, sending second read sequences to the memory device, wherein the second read sequences indicate to read the first data, and
wherein the memory controller does not send read sequences to the memory device in response to receiving the third read command.

12. The memory system of claim 1, wherein the operations comprise:
in response to receiving the first read command, receiving the first data from the memory device; and
in response to receiving the second read command, receiving the first data from the memory device, and
wherein the memory controller does not receive data from the memory device in response to receiving the third read command.

13. A memory controller, comprising one or more processors, a buffer, and an interface, wherein the one or more processors are configured to perform operations comprising:
receiving, through the interface, a first read command that indicates to read first data associated with a first logical address;
in response to receiving, through the interface, a second read command that indicates to read the first data associated with the first logical address, storing the first data in the buffer, and wherein the first data remains in the buffer after the second read command is completed; and
in response to receiving, through the interface, a third read command that indicates to read the first data associated with the first logical address, sending the first data from the buffer.

14. The memory controller of claim 13, wherein a duration of executing the third read command is shorter than a duration of executing the first read command or the second read command.

15. The memory controller of claim 13, wherein the first read command and the second read command are received within a pre-set duration, and the second read command and the third read command are received within the pre-set duration.

16. The memory controller of claim 13, wherein the operations comprise:
after receiving the first read command, storing the first logical address in the memory controller.

17. The memory controller of claim 16, wherein the operations comprise:
in response to receiving a fourth read command that indicates to read second data associated with a second logical address:
deleting the first data from the buffer; and
storing the second logical address in the memory controller in replacement of the first logical address.

18. The memory controller of claim 16, wherein the operations comprise:
in response to receiving a write command or a trim command:
deleting the first data from the buffer; and
deleting the first logical address stored in the memory controller.

19. The memory controller of claim 13, wherein the operations comprise:
in response to receiving the first read command, sending first read sequences to a memory device coupled to the memory controller, wherein the first read sequences indicate to read the first data; and
in response to receiving the second read command, sending second read sequences to the memory device, wherein the second read sequences indicate to read the first data, and
wherein the memory controller does not send read sequences to the memory device in response to receiving the third read command.

20. A method of operating a memory system, comprising:
receiving a first read command that indicates to read first data associated with a first logical address;
in response to receiving a second read command that indicates to read the first data associated with the first logical address, storing the first data in a buffer of a memory controller of the memory system, wherein the first data remains in the buffer after the second read command is completed; and
in response to receiving a third read command that indicates to read the first data associated with the first logical address, sending the first data from the buffer.
